(19) United States
(12) Patent Application Publication
(10) Pub. No.: US 2014/0115076 A1
(43) Pub. Date: Apr. 24, 2014

(54) Anonymous Notification System and Method with Reduced Traceability on End Device

(71) Applicant: VaporStream Incorporated, Chicago, IL (US)

(72) Inventor: Amit Jindas Shah, Chicago, IL (US)

(73) Assignee: VaporStream Incorporated, Chicago, IL (US)

(21) Appl. No.: 14/033,135

(22) Filed: Sep. 20, 2013

Related U.S. Application Data
(60) Provisional application No. 61/703,486, filed on Sep. 20, 2012.

(51) Int. Cl. H04L 12/58

(52) U.S. Cl. CPC H04L 51/24
USPC 709/206

(57) ABSTRACT

A notification server that allows one or more user devices to be associated with one or more third-party service providers such that the one or more third-party service providers can send a notification to the one or more user devices. In one example, a notification server utilizes a user/provider ID to associate a user device with a third-party service provider. A notification may also remove identifying information of a third-party service provider from a notification prior to providing the notification to the user device. A user/provider ID may allow for reduced traceability via its specific association with a particular third-party service provider. Systems and methods for anonymous notification take advantage of the mechanisms of user/provider ID assignment and other aspects to reduce traceability.

### RELATED APPLICATION DATA

This application claims the benefit of priority of U.S. Provisional Patent Application Ser. No. 61/703,486 filed Sep. 20, 2012, and titled “Anonymous Notification System and Method with Reduced Traceability on End Device,” which is incorporated by reference herein in its entirety.

### FIELD OF THE INVENTION

The present invention generally relates to the field of electronic notification/messaging in online environments. In particular, the present invention is directed to an anonymous notification system and method with reduced traceability.

### BACKGROUND

Users on the Internet and other networks often are members of online services. These online services may send notifications to the user such that the online service provider needs to know an address of the user and/or the notification that comes to the user includes identifying information about the online service. Often, identifying information about a user may be repackaged and sold by the online service provider to another entity sometimes along with identifying information from other users. Proxy servers exist to act as intermediaries between users of one computer and a second computer. For example, a user may access an online service provider by first accessing a proxy server. The proxy server can project to the online service provider a different address and/or different information about the user than would be provided if the user accessed the online service provider directly from their computer.

### SUMMARY OF THE DISCLOSURE

In one implementation, a computer implemented method for providing notifications at a user device from an online third-party service provider is provided. The method includes receiving a first request from the first user device at the recordless notification server to use the recordless notification server; assigning a device ID to the first user device, the device ID identifying the first user device to the recordless notification server; associating a first service ID with the device ID using the recordless notification server; receiving a first notification from a first third-party service provider at a recordless notification server, the first notification including a first user/provider ID that is based on the first service ID, the first notification intended for delivery to a user of the first third-party service provider; and providing the first notification to the first user device with the recordless notification server using the first user/provider ID to correlate to the first user device of the user.

In another implementation, a computer readable hardware storage medium containing computer executable instructions implementing a method of providing notifications at a user device from an online third-party service provider is provided. The instructions include a set of instructions for receiving a first request from the first user device at the recordless notification server to use the recordless notification server; a set of instructions for assigning a device ID to the first user device, the device ID identifying the first user device to the recordless notification server; a set of instructions for associating a first service ID with the device ID using the recordless notification server; a set of instructions for receiving a first notification from a first third-party service provider at a recordless notification server, the first notification including a first user/provider ID that is based on the first service ID, the first notification intended for delivery to a user of the first third-party service provider; and a set of instructions for providing the first notification to the first user device with the recordless notification server using the first user/provider ID to correlate to the first user device of the user.

In still another implementation, a system for providing notifications at a user device from an online third-party service provider is provided. The system includes a means for receiving a first request from the first user device at the recordless notification server to use the recordless notification server; a means for assigning a device ID to the first user device, the device ID identifying the first user device to the recordless notification server; a means for associating a first service ID with the device ID using the recordless notification server; a means for receiving a first notification from a first third-party service provider at a recordless notification server, the first notification including a first user/provider ID that is based on the first service ID, the first notification intended for delivery to a user of the first third-party service provider; and a means for providing the first notification to the first user device with the recordless notification server using the first user/provider ID to correlate to the first user device of the user.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one example of an arrangement of a third-party service provider, notification server, and user device;

FIG. 2 illustrates one example of a method of providing notifications;

FIG. 3 illustrates another example of an arrangement of a notification system and method;

FIG. 4 illustrates another example of a method of providing notifications;

FIG. 5 illustrates an example of a method for associating a third-party service provider with a notification server;

FIG. 6 illustrates yet another example of a system and method for providing notifications;

FIG. 7 illustrates one example of a method of associating two or more user devices with a notification server;

FIG. 8 illustrates another example of a method of associating two or more user devices with a notification server; and

FIG. 9 illustrates one example of a computing device.

### DETAILED DESCRIPTION

A user of a computer device may desire to receive notifications from a third party service provider (“3PSP”). In some circumstances, the user may desire to keep all or a portion of the user's identity from the 3PSP. Additionally, the user may desire to keep the identity of the 3PSP from being discovered by an entity that may have access to a device at which the notification may be provided, to a network between the 3PSP and the device, and/or to another access point between the user and the 3PSP. For example, the user may wish to keep the identity of the 3PSP from detection by the Internet Service Provider (ISP) being used by the user. The anonymous notification systems and methods described herein address these and other concerns in a manner that is different than simply using a conventional proxy service.

In one implementation, a recordless notification server (RNS) is utilized between a computing device of a user and a 3PSP to which the user has an association (e.g., the user is a member of or subscriber to one or more services of the 3PSP). The recordless notification server may also be associated with one or more 3PSP's. Example associations of a RNS with a 3PSP include, but are not limited to, an association created by a user of an RNS (e.g., as discussed below with respect to associating one or more user devices with an RNS and associating one or more 3PSP's with the one or more user devices using the RNS), an association created by a business relationship between an operator of a RNS and a 3PSP, and any combinations thereof A recordless notification server may be operated by a recordless notification service provider (RNP). In one example, an RNP is operated by the same entity that operates one or more 3PSP's associated with an RNP (or its RNS). In another example, an RNP is operated by an entity other than an entity operating a 3PSP associated with an RNP (or its RNS). With the use of a RNS and/or RNP, a user and/or the 3PSP may desire to keep all or a portion of the user's actual identity as used with the 3PSP from being detectable by the recordless notification server and/or the RNP.

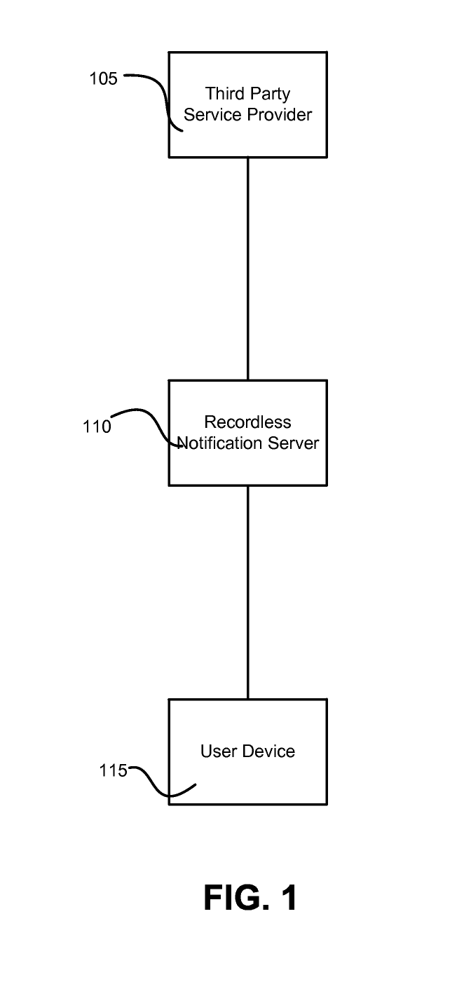

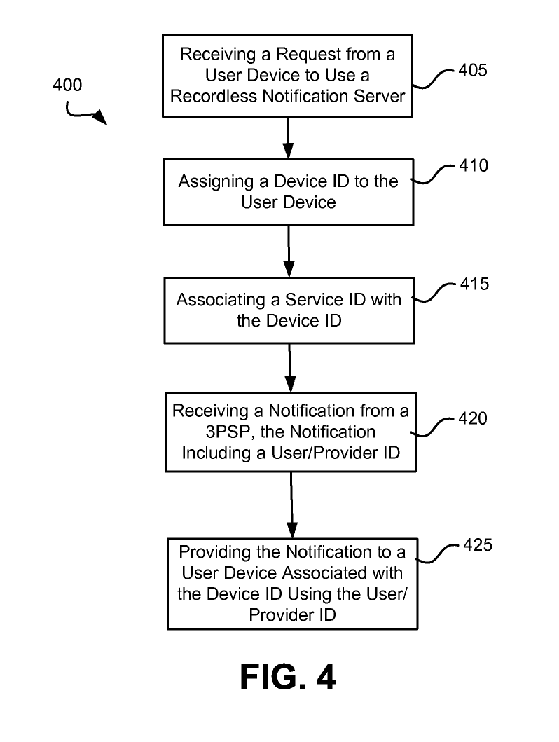

FIG. 1 illustrates one example of an arrangement of a 3PSP 105, an RNS 110, and a user device 115 (i.e., a computing device). 3PSP 105 is shown with a connection to RNS 110. This connection may include one or more networks. RNS 110 is shown with a connection to user device 115. This connection may include one or more networks. A connection (not shown) between 3PSP 105 and user device 115 may also be included to allow user device 115 to communicate with 3PSP 105 for one or more purposes as will be understood from the description below. Such a connection between 3PSP 105 and user device 115 may include one or more networks. Although FIG. 1 illustrates one 3PSP 105, any number of 3PSP's may be associated with an RNS to allow a user to receive notifications from multiple 3PSP's at one or more devices of the user. Additionally, one user device 115 is shown in FIG. 1. A user may associate any number of user devices with an RNS to allow a user to receive notifications from one or more 3PSP's at any number of user devices. Exemplary implementations having multiple 3PSP's associated with an RNS and/or multiple user devices associated with an RNS are discussed further below (e.g., with respect to examples and implementations of FIGS. 4 to 8).

A notification may include any information that a 3PSP may communicate to a user. Examples of information of a notification include, but are not limited to, an indication of a further message available from a 3PSP, an indication of a further data available from a 3PSP, an indication of an action of a 3PSP, a message from a 3PSP, an indication of a number of messages available from a 3PSP, an actual message, and any combinations thereof. A notification may be in any form of electronic communication. Examples of a form of electronic communication for a notification include, but are not limited to, a text form, a graphical form, a photographic form, a video form, a file attachment, and any combinations thereof. Example messages that may be included as a notification include, but are not limited to, a text message, a graphical message, a photographic message, a video message, and any combinations thereof.

3PSP 105 includes one or more computing devices that are specially programmed and configured to provide one or more services to a user over one or more electronic networks, such as the Internet. Example services of a 3PSP include, but are not limited to, a social network service, a video streaming service, an e-commerce website, an online dating service, an online adult service, other online services, an email service, and any combinations thereof.

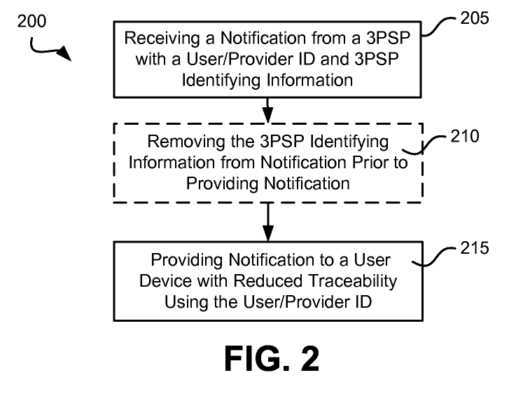

RNS 110 includes one or more computing devices that are specially programmed and configured to receive notifications from 3PSP 105 and provide them with reduced traceability to user device 115. Additionally, RNS 110 may allow user device 115 to interact with 3PSP 105 with reduced traceability of user device 115 and/or a user of user device 115 at 3PSP 105 and at RNS 110. Example ways for RNS 110 to reduce traceability include, but are not limited to, allowing user device 115 to communicate with 3PSP 105 without giving 3PSP 105 information that would specifically identify a user of user device 115, using a unique identifier (e.g., a user/provider ID as discussed further below) between 3PSP 105 and RNS 110 that allows RNS 110 to deliver a notification to user device 115 without 3PSP 105 providing to RNS 110 all or a portion of the actual identity of the user of user device 115 as that user is identified by 3PSP 105, using RNS 110 to remove identifying information from one or more layers of a notification from 3PSP 105 such that the notification as delivered to user device 115 does not have one or more indications of identity of 3PSP 105. Examples of systems and methods employed by RNS 110 for reducing traceability are discussed further below (e.g., with respect to FIGS. 2 to 8). These systems and methods differ from, and provide benefits over, basic proxy-type services.

User device 115 includes one or more computing devices for allowing a user to interact with RNS 110 and/or interact with 3PSP 105. User device 115 may interact with RNS 110 in a variety of ways. Example ways for a user device 115 to interact with RNS 110 include, but are not limited to, user device 115 using specific application programming on user device 115 (e.g., an application downloadable over a network from RNS 110 or another computing device associated with the corresponding RNP) that provides user device 115 with functionality for interacting with RNS 110 according to one or more of the exemplary interactions described in the implementations of the current disclosure between a user device and an RNS, user device 115 accessing RNS 110 using one or more standard functionalities (e.g., using an Internet browser on user device 115 to access a user interface served over the Internet by RNS 110), and any combinations thereof. User device 115 may interact with 3PSP 105 in a variety of ways. Example ways for user device 115 to interact with RNS 110 include, but are not limited to, user device 115 accessing 3PSP 105 using one or more standard functionalities of user device 115 (e.g., using an Internet browser on user device 115 to access a user interface served over the Internet by 3PSP 105), using another user interface, and any combinations thereof.

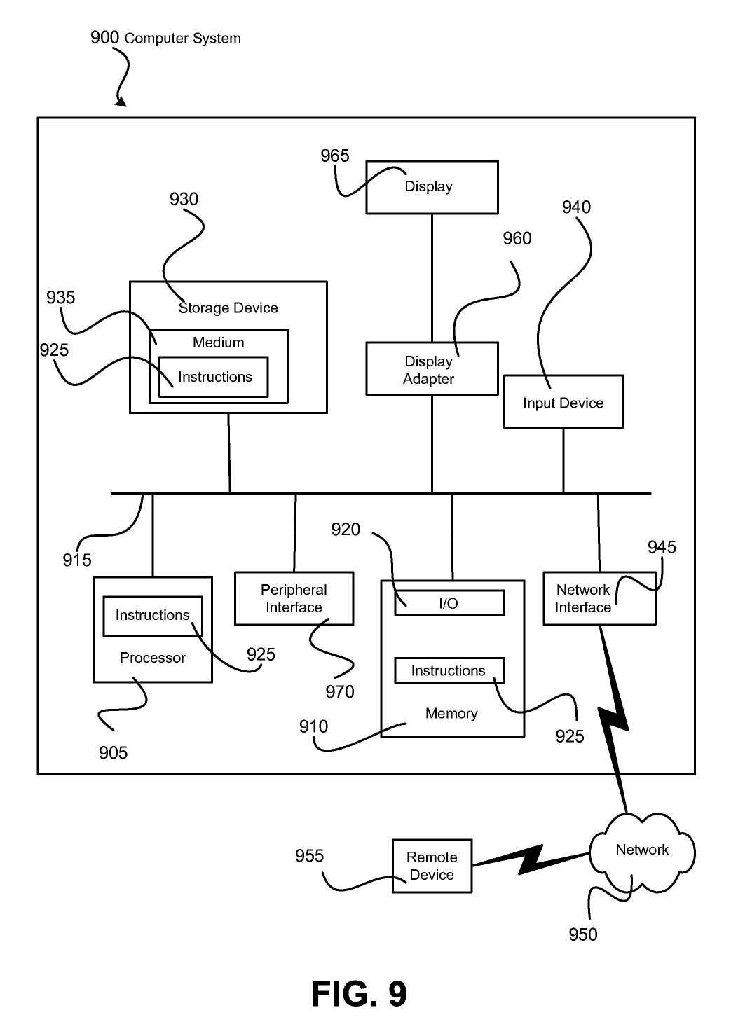

Example computing devices include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk. One or more computing devices may include appropriate hardware and be specially programmed with appropriate instructions to perform one or more of the specific tasks outlined in one or more of the implementations described in this application. One example of a computing device is described below with respect to FIG. 9. It is noted that each of 3PSP 105, RNS 110, and user device 115 may include any number of computing device with one or more features of each of the components distributed across one or more computing devices.

Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In examples shown herein, a single network may be depicted. It is understood that where two or more devices are connected via a network, the network may include any number of network types in the overall network connection between devices. For example, a user's mobile smartphone computing device may be connected to a computing device of a third party service provider via a series of networks such as a mobile telephone network (voice and/or data) that includes a wireless network connection between the smartphone and a mobile tower network of the mobile smartphone service provider, a wired network of the mobile smartphone service provider, the Internet connecting the mobile smartphone service provider to an Internet Service Provider (ISP) of the third party service provider, a network of the third party service provider connecting the ISP's network to the computing device of the third party service provider. It should also be understood that where two or more networks are illustrated in an example herein, that the two or more networks may share one or more network elements. For example, where a network is shown between a 3PSP and a notification server and another network is shown between the 3PSP and a user device, the two networks may both include one or more of the same networks (e.g., the Internet, a user's smartphone service provider's network). In general, any network topology may be used.

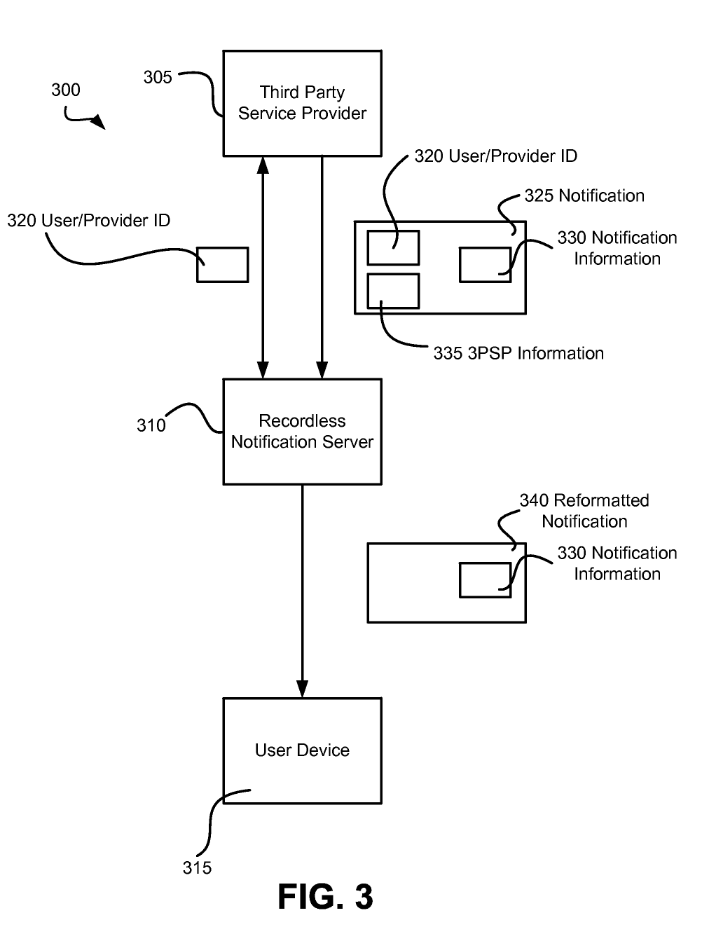

FIG. 2 illustrates one example of a method 200 of providing anonymous notifications. FIG. 3 illustrates another exemplary implementation 300 of an arrangement of an anonymous notification system and method. The implementation shown in FIG. 3 is similar to that of FIG. 1. Elements, devices, and features shown in FIG. 3 share characteristics and details with their corresponding elements, devices, and features as discussed above with respect to FIG. 1 except as indicated. Implementation 300 includes a 3PSP 305, a RNS 310, and a user device 315, each having the same features as discussed above with respect to 3PSP 105, RNS 110, and user device 115, except as provided.

Method 200 is described in relation to relevant aspects of implementation 300 for illustrative purposes. Method 200 may be implemented with a different arrangement as will be apparent to those skilled in the art from this entire disclosure. Method 200 includes, at step 205, receiving a notification from a 3PSP. The notification includes a user/provider ID. For example, notification 325 is shown being received by RNS 310 from 3PSP 305. Notification 325 includes user/provider ID 320.

In one exemplary aspect, a user/provider ID may serve as an anonymous mechanism for correlating 3PSP 305 (and notification provided from 3PSP 305) with user device 315 and/or a user of user device 315. In one example, a user/provider ID includes unique identifying information (e.g., an alphanumeric string) that is unique to the 3PSP and the user of the 3PSP. In one such example, the user/provider ID (e.g., user/provider ID 320) does not disclose to RNS 310 or an operator of RNS 310 information that would identify a user of user device 315 with an actual identity that is used by 3PSP 305 to otherwise identify the user (e.g., the user/provider ID would not include a name of the user or an email address). User/provider ID 320 may be randomly generated. User/provider ID 320 may include any form of information that allows RNS 310 to correlate 3PSP 305 with user device 315 and/or a user of user device 315. Example forms of information for a user/provider ID 320 include, but are not limited to, a text identifier, an alphanumeric indicator, a graphical indicator, an indicator including an identification of user device 315, an indicator including an identification of 3PSP 305, an indicator that is unique to 3PSP 305 (e.g., each 3PSP associated with an RNS for a user and/or one or more of the user's devices can have a unique user/provider ID), and any combinations thereof. In one example, user/provider ID 320 does not include information of the specific identity of a user of user device 315 (e.g., user/provider ID 320 can allow a user of user device 315 to receive notifications from 3PSP 305 anonymously and does not include information that would allow 3PSP (or an operator thereof) and/or RNS (or an operator thereof) to identify the user). In an example where more than one user device of a user are associated with RNS 310, a user/provider ID (e.g., user/provider ID 320) may include information that RNS 310 can utilize to associate 3PSP 305 with each of the associated user devices.

RNS 310 may include a memory for storing correlation information that associates a user/provider ID with a 3PSP and one or more user devices (and/or a user of the one or more user devices). Examples of correlation information include, but are not limited to, a cross-over table, a set of linking data that links a user/provider ID and a user device (and/or a user of a user device), a set of linking data that links a user/provider ID and multiple user devices, a set of linking data that links a user/provider ID and a user of one or more user devices, a device ID that identifies a user device, a set of linking data that links a user/provider ID and one or more device ID's, and any combinations thereof.

3PSP 305 may receive user/provider ID in a variety of ways. Example ways for 3PSP 305 to receive user/provider ID include, but are not limited to, 3PSP 305 being provided with a user/provider ID by RNS 310; 3PSP 305 being provided with a user/provider ID by a user of user device 315; 3PSP 305 being provided with a service ID (discussed further below) by a user of user device 315; 3PSP 305 using a service ID provide by a user of user device 315 as a user/provider ID; 3PSP 305 receiving a service ID from a user of user device 315, providing the service ID to RNS 310, receiving from RNS 310 a user/provider ID in response to the service ID; and any combinations thereof.

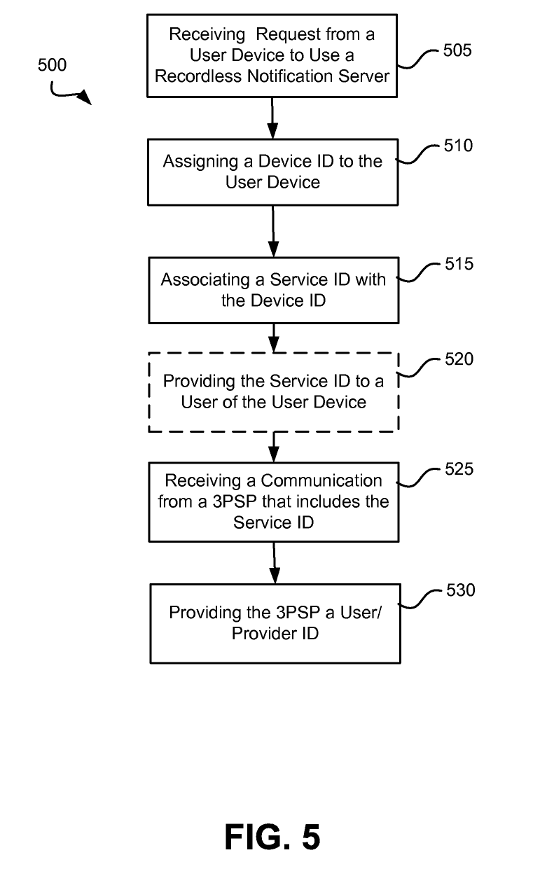

In one example, RNS 310 is configured to generate user/provider ID 320 and to provide user/provider ID 320 to 3PSP 305 in a communication between RNS 310 and 3PSP 305. FIG. 3 illustrates a communication between 3PSP 305 and RNS 310 in which user/provider ID is provided to 3PSP 305. In one example, this communication includes RNS 310 receiving a service ID from 3PSP 305. In one such example, the service ID is provided to 3PSP 305 by a user of user device 310 after RNS 310 provides the service ID to user device 310. An example method for generating a user/provider ID with use of a service ID is discussed further below with respect to FIG. 5.

RNS 310 is shown receiving a notification 325 from 3PSP 305. Notification 325 is intended for delivery to user device 315 and/or a user of user device 315. Notification 325 includes notification information 330. Notification 325 also optionally includes 3PSP identifying information 335. At optional step 210 of method 200, the 3PSP identifying information may be removed from the notification prior to providing the notification to a user device (e.g., user device 315). In an alternative implementation, notification 325 may be received by RNS 310 from 3PSP 305 without indications of the identity of 3PSP 305 (e.g., 3PSP 305 removes any such indications prior to providing notification 325 to RNS 310). Such an alternative implementation may include all the features of any of the other implementations of this disclosure that are consistent with a notification that is received by an RNS already lacking identifying information about a 3PSP

Examples of indications of the identity of a 3PSP that may be included with a notification include, but are not limited to, metadata (e.g., metadata associated with a textual, graphical, photographic element of a notification), a hyperlink to an Internet address associated with a 3PSP, a hyperlink to an Internet address associated with an entity other than a 3PSP (e.g., an entity that may provide indirect identification of the 3PSP), an Internet address of a 3PSP, a data expressing the identity of a 3PSP, and any combinations thereof A notification according to the current disclosure includes two layers of information. A first layer is a payload information layer. A payload information layer includes the information discernible by a user that receives the notification when the notification is presented to the user. A second layer is a network information layer. A network information layer includes information that is discernible without opening/presenting the substantive information of the notification at a network level. For example, a packet of data representing a notification may include IP (Internet Protocol) information that allows a viewer at the network level to discern where a notification originated and where a notification is addressed. This information is different from the information within the notification that is discernible only when the notification is presented in a normal fashion (e.g., by RNS 310 to user device 315 using a displayable image of the contents of notification information 330. Indications of the identity of a 3PSP may be present in a network information layer (e.g., network addressing information for the packet), a payload information layer (e.g., a data indication of the sender of the notification), or both. In one example, RNS 310 removes one or more indications of the identity of a 3PSP from a network information layer of a notification. In another example, RNS 310 removes one or more indications of the identity of a 3PSP from a payload information layer. In yet another example, RNS 310 removes one or more indications of the identity of a 3PSP from both a network information layer of a notification.

RNS 310 is configured to (1) remove one or more indications of identity of 3PSP 305 included with notification 325 and/or (2), in an implementation where 3PSP 305 may send notification 325 without identifying information, check notification 325 for any indication of the identity of 3PSP 305 and remove one or more indications of the identity of 3PSP 305 found by the check.

At step 215, user/provider ID 320 is used to provide notification 325 and its notification information 330 to user device 315 with reduced traceability. In FIG. 3, RNS 310 is shown providing a reformatted notification 340 to user device 315. Reformatted notification 340 does not include 3PSP information 335 or user/provider ID 320. In alternate implementations, 3PSP information 335 and/or user/provider ID 320 may be provided with notification 340 to user device 315.

In one example, reduced traceability is achieved by use of user/provider ID 320 allowing notification 325 to be received by RNS 310 without 3PSP 305 disclosing an actual identity to RNS 310. In one such example, an operator of RNS 310 does not have access to information about the users of 3PSP 305 that can be used by the operator or another entity to identify users except for being able to send notifications via RNS 310 to one or more user devices associated with RNS 310. In another aspect, a security breach that reveals correlations between user/provider ID's and user devices does not disclose actual identifying information about a user of 3PSP 305. In another example, reduced traceability is achieved by use of user/provider ID 320 being provided to 3PSP3 as user/provider ID 320 and/or as a service ID, each of which do not provide specific identifying information about a user of user device 315. In one such example, a user can utilize 3PSP3 to provide notifications via RNS 310 without providing certain information to 3PSP3, such as an email address or other identifying information. In yet another example, reduced traceability is achieved by removal of part or all of 3PSP identifying information from a network information layer and/or a payload information layer of a notification.

Additionally, a notification may be additionally configured (e.g., to increase the reduction in traceability). Example ways of configuring a notification include, but are not limited to, changing a network (e.g., Internet) address associated with the sending 3PSP of the notification, changing a network (e.g., Internet) address associated with a sender of a message included in a notification, changing an address associated with a notification to an address (e.g., an Internet address) associated with an RNS, changing a message content format to an image format (e.g., a *.jpg, *.bmp, *.pdf, etc. format), removing a hyperlink to a 3PSP from a notification (e.g., removing from a payload information layer), downloading a hyperlinked information in a notification to a memory associated with an RNS and changing a reference in the notification to the hyperlinked information to point to the information on the memory, rewriting a content of a notification in a format that removes a reference to a 3PSP (e.g., rewriting an address or other reference at the time the notification is communicated from the 3PSP to the RNS), and any combinations thereof. Any two or more aspects of reduced traceability and/or additional configurations may be combined to increase reduced traceability.

FIG. 4 illustrates another example of a method 400 of providing anonymous notifications. Features and benefits of the implementations described above with respect to FIGS. 1 to 3 (including, but not limited to, those directed to reduced traceability, use of a user/provider ID, removal of 3PSP identifying information, etc.) apply to corresponding aspects of method 400, except as indicated. Additionally, it is contemplated that features discussed with respect to method 400 can be combined with any of the implementations discussed with respect to FIGS. 1 to 3.

At step 405, a request is received from a user device (e.g. user device 315) at an RNS (e.g., RNS 310) for the user device to utilize the RNS for anonymous notifications.

At step 410, the RNS assigns a device ID to the user device. A device ID identifies the user device to the RNS. Information related to the device ID may be stored in a memory of the RNS and used by the RNS to identify a user device and/or a user of the user device.

At step 415, a service ID is associated with the device ID. A service ID is an identifier that can be used by the RNS to communicate with a 3PSP on behalf of a user device. A service ID may be a unique identifier that correlates a device ID to a 3PSP. In one example, a service ID is used directly by a 3PSP (e.g., after being received from a user of a user device associated with an RNS) to send a notification to the RNS. In another example, a service ID is used by a 3PSP to request a user/provider ID from the RNS, the user/provider ID being correlated to a device ID via the service ID by the RNS. In one example, a service ID does not disclose to a 3PSP or an operator of the 3PSP information that would identify a user of the user device. A service ID may be randomly generated. In one example, a service ID may include any form of information that allows an RNS to (a) provide a 3PSP with a user/provider ID that correlates to a device ID and/or (b), correlate a 3PSP with a user device via a device ID. Example forms of information for a service ID include, but are not limited to, a text identifier, an alphanumeric indicator, a graphical indicator, and any combinations thereof. In one example, a service ID does not include information of the specific identity of a user of user device. In an example where more than one user device of a user are associated with an RNS a service ID may include information that RNS can utilize to associate a 3PSP with each of the associated user devices.

In one example, a service ID may be utilized once by a user to associate a 3PSP with an RNS. In one such example, a service ID may be used once by a 3PSP to obtain a user/provider ID and then reused at a later date by the RNS. In another example, a service ID may be used multiple times (e.g., to associate two or more 3PSP's with an RNS.

At step 420, a notification is received at the RNS from a 3PSP. The notification includes a user/provider ID that is based on the service ID from step 415. The user/provider ID may be based on the service ID in a variety of ways. In one example, a user/provider ID is based on a service ID by being the same value as the service ID. In one such example, the 3PSP receives the service ID from a user of the associated user device and uses the service ID as the user/provider ID when sending a notification to the RNS. A decision to use a service ID as a user/provider ID may occur in a variety of ways. Example ways to determine to use a service ID as a user/provider ID include, but are not limited to, an RNS instructing a 3PSP in a communication with the 3PSP to use a service ID as a user/provider ID, an instruction at a 3PSP established in a preexisting business relationship between the 3PSP and an RNS, an instruction from a user providing a service ID to a 3PSP to use the service ID as a user/provider ID, and any combinations thereof. In another example, a user/provider ID is based on a service ID by receiving a communication at an RNS from a 3PSP that includes a service ID (e.g., a service ID provided to the 3PSP by a user of an associated user device) and providing from the RNS to the 3PSP the user/provider ID.

At step 425, the notification is provided by the RNS to the user device associated with the user/provider ID. In one example, an RNS uses a correlation of the user/provider ID to a device ID (e.g., a correlation stored in a memory of the RNS) to identify the user device to which to deliver the notification having the user/provider ID.

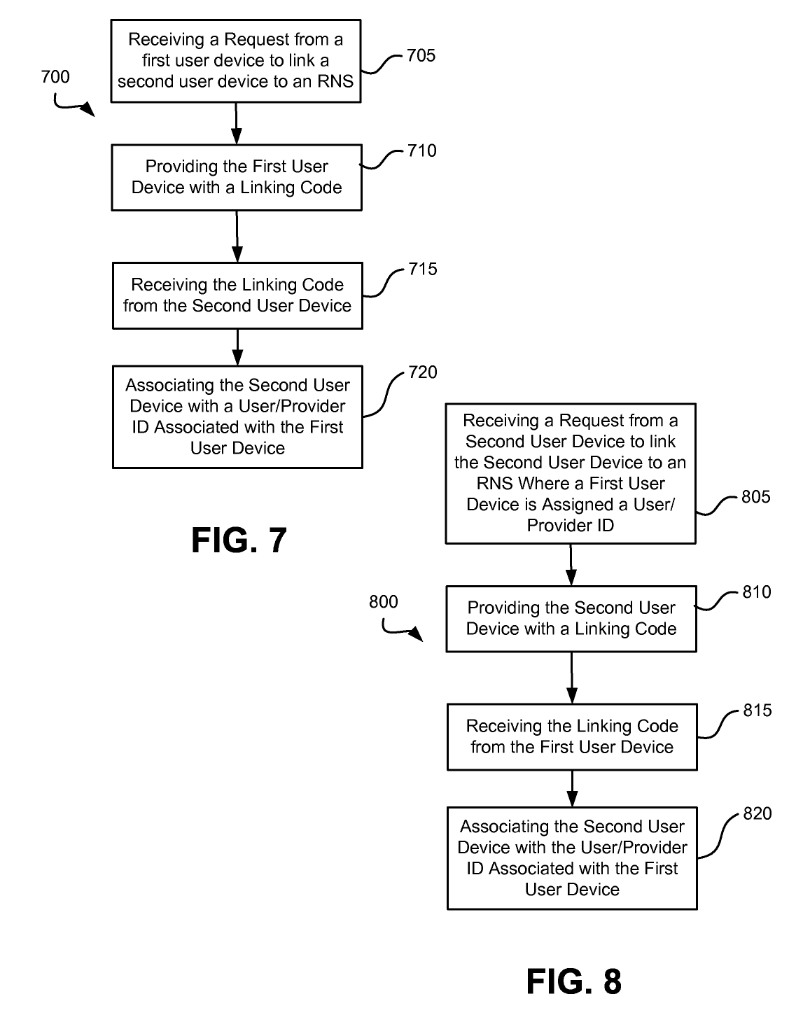

In any of the implementations discussed herein, a user may associate two or more user devices with an RNS such that notifications from one or more 3PSP's associated with the RNS for the user will be provided by the RNS to the two or more user devices. Examples of methods for associating multiple user devices with an RNS are discussed further below (e.g., with respect to FIGS. 7 and 8). In any of the implementations discussed herein, a user may associate more than one 3PSP with an RNS such that notifications from more than one 3PSP are provided by the RNS to one or more devices that the user has associated with the RNS (e.g., by associating more than one device ID with each of a user/provider ID for each 3PSP). In one example, the steps 415 to 425 may be repeated for each user device such that a second service ID is associated with a device ID for each user device, a second notification is received by the RNS from a second 3PSP (the notification having a second user/provider ID), and providing the second notification to each user device by correlating the second user/provider ID with each device ID.

FIG. 5 illustrates one example of a method 500 for associating a 3PSP with a RNS for anonymous notifications to a user device. Features and benefits of the implementations described above with respect to FIGS. 1 to 4 (including, but not limited to, those directed to reduced traceability, use of a user/provider ID, removal of 3PSP identifying information, association of multiple 3PSP's, association of multiple user devices, etc.) apply to corresponding aspects of method 500, except as indicated. Additionally, it is contemplated that features discussed with respect to method 500 can be combined with any of the implementations discussed with respect to FIGS. 1 to 4.

At step 505, a request is received at an RNS from a user device to utilize the RNS. At step 510, a device ID is assigned to the user device. At step 515 a service ID is associated with the device ID. At optional step 520, the service ID is provided to a user of the user device such that the user can provide the service ID to a 3PSP. One exemplary alternate implementation include the RNS providing the service ID to the 3PSP. In one such example, a user may access the RNS (e.g., via a user interface of the RNS presented on the user device), request that a specific 3PSP be associated with a user device (e.g., using a pre-established relationship between the RNS and the 3PSP in which the RNS displays available 3PSP's for use with the RNS), and the RNS sends the service ID to the selected 3PSP. In another alternate implementation, a similar process could be utilized to send a user/provider ID from the RNS to the 3PSP. In one exemplary aspect, this may avoid the need to have the 3PSP send a service ID to the RNS and the RNS sending in response a user/provider ID. One possible exemplary benefit to using a separate service ID from a user/provider ID that applies to the various implementations described in this disclosure may be that a service ID can have a smaller size (e.g., 40 bits) from a user/provider ID (e.g., 256 bits). In such a situation a burden on a user that has to enter a service ID (e.g., one provided to it by an RNS upon request) to a user interface of a 3PSP (smaller size of a temporary ID used once to set up the 3PSP with the RNS) is balanced with security concerns (larger bit size of the permanent user/provider ID that is used with each notification from the specific 3PSP to the RNS for that user device).

At step 525, a communication is received at the RNS from a 3PSP. The communication includes the service ID. At step 530, the RNS provides the 3PSP with a user/provider ID that correlates to the device ID that was associated with the service ID. The 3PSP can then utilize the user/provider ID to send one or more notifications to the RNS for providing to the user device.

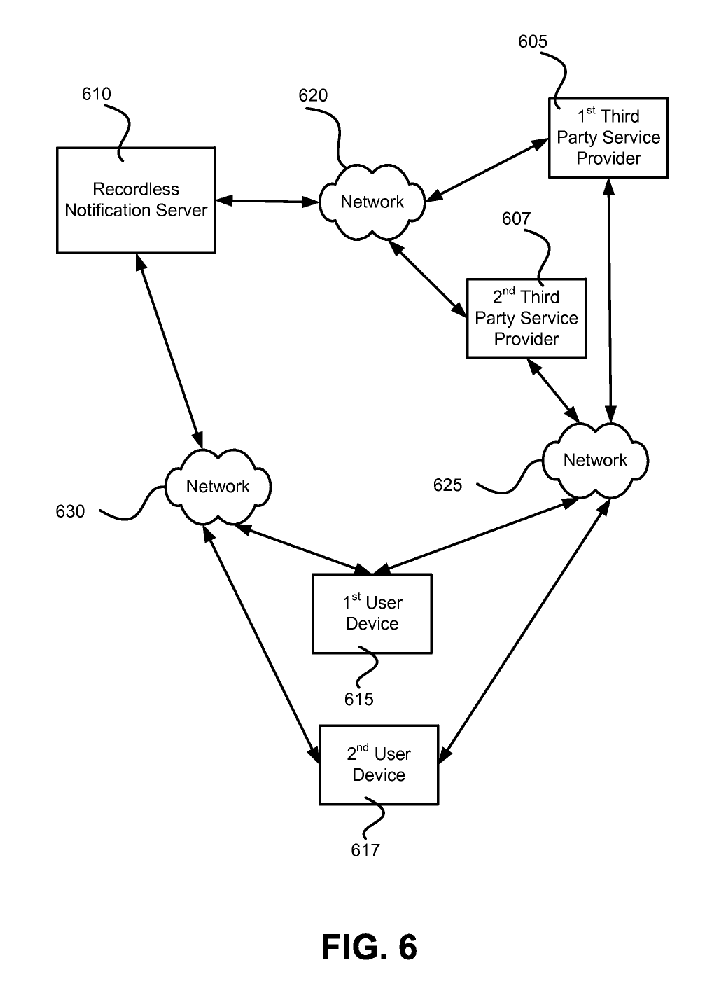

FIG. 6 illustrates another example of an implementation of a system and method for providing anonymous notifications. Features and benefits of the implementations described above with respect to FIGS. 1 to 5 (including, but not limited to, those directed to reduced traceability, use of a user/provider ID, removal of 3PSP identifying information, association of multiple 3PSP's, association of multiple user devices, etc.) apply to corresponding aspects of implementation 600, except as indicated. Additionally, it is contemplated that features discussed with respect to implementation 600 can be combined with any of the implementations discussed with respect to FIGS. 1 to 5.

FIG. 6 illustrates a first third-party service provider 605 and a second third-party service provider that each can be associated with an RNS 610 using one or more of the features and implementations described herein. Any number of 3PSP's may be associated with RNS 610. Two are used here as an illustrative example. A first user device 615 and a second user device 617 are shown and can each be associated with RNS 610 using one or more of the features and implementations described herein. Any number of user devices may be associated with RNS for providing notifications from one or more 3PSP's on behalf of a user of the user devices.

3PSP's 605 and 607 are shown as connected to RNS 610 via network 620 and to user devices 616 and 617 via network 625. User devices 616 and 617 are shown as connected to RNS 610 via network 630. Each of networks 620, 625, 630 include one or more network components. In one example, one or more elements of any one of networks 620, 625, 630 may be shared with another one of networks 620, 625, 630. For example, each of networks 620, 625, 630 may include the Internet.

FIG. 7 illustrates one exemplary method 700 of associating two or more user devices with an RNS. Features and benefits of the implementations described above with respect to FIGS. 1 to 6 (including, but not limited to, those directed to reduced traceability, use of a user/provider ID, removal of 3PSP identifying information, association of multiple 3PSP's, association of multiple user devices, etc.) apply to corresponding aspects of method 700, except as indicated. Additionally, it is contemplated that features discussed with respect to method 700 can be combined with any of the implementations discussed with respect to FIGS. 1 to 6 (e.g., two or more user devices may be linked to an RNS, such as RNS 110, RNS 310).

At step 705, an RNS receives a request from a first user device (e.g., a first user device that is already associated with the RNS and a 3PSP using a user/provider ID) to link a second user device to the RNS. An RNS may include a user interface for a user of the first user device to make such a request.

At step 710, the RNS provide the first user device with a linking code that is associated with the first user device at the RNS. In one example, information correlating the linking code with a device ID of the first user device is stored in a memory of the RNS. A linking code can be any information that allows the RNS to associate the first user device to the RNS. In one example, a linking code is a device ID associated with the first user device. In another example, a linking code is a randomly generated data value.

At step 715, the linking code is received at the RNS from the second user device. An RNS may include a user interface for a user of the second user device to input the linking code to the RNS.

At step 720, the second user device is associated (i.e., using the linking code) with a user/provider ID that is associated at the RNS with the first user device. In one example, a second device ID is assigned to the second user device and the second device ID is correlated with the user/provider ID (e.g., using information stored in a memory of the RNS). The correlation between the second user device and the user/provider ID can be utilized to provide a notification from a 3PSP associated with the user/provider ID to the second user device and/or the first user device. One or more of the steps of method 700 may be repeated to associate the second user device with additional user/provider ID's for additional 3PSP's that are associated with the first user device.

Referring back to FIG. 6, one example implementation of method 700 includes first user device 615 being associated with a first user/provider ID with first 3PSP 605. In this example, a user of first user device 615 accesses a user interface of RNS 610 (i.e., requests at step 705) to receive from RNS 610 a linking code that associates first user device 615 to RNS 610 (step 710). The user then accesses RNS 610 using second user device 617 and provides the linking code to the RNS 610, for example via an user input interface of RNS 610 (step 715). The RNS associates second user device 617 with the first user/provider ID.

FIG. 8 illustrates one exemplary method 800 of associating two or more user devices with an RNS. Features and benefits of the implementations described above with respect to FIGS. 1 to 6 (including, but not limited to, those directed to reduced traceability, use of a user/provider ID, removal of 3PSP identifying information, association of multiple 3PSP's, association of multiple user devices, etc.) apply to corresponding aspects of method 800, except as indicated. Additionally, it is contemplated that features discussed with respect to method 800 can be combined with any of the implementations discussed with respect to FIGS. 1 to 6 (e.g., two or more user devices may be linked to an RNS, such as RNS 110, RNS 310).

At step 805, an RNS receives a request from a second user device to link the second user device to the RNS where a first user device is already associated with the RNS using a first user/provider ID. An RNS may include a user interface for a user of the second user device to make such a request.

At step 810, the RNS provides the second user device with a linking code that is associated with the second user device at the RNS. In one example, information correlating the linking code with a device ID of the second user device is stored in a memory of the RNS. A linking code can be any information that allows the RNS to associate the second user device to the RNS. In one example, a linking code is a device ID associated with the second user device. In another example, a linking code is a randomly generated data value. In yet another example, a linking code includes a device ID associated with the first user device (e.g., the RNS can use the device ID of the first user device and a correlation of that device ID to a second device ID associated with the second user device to make the correlation between the two user devices at step 820).

At step 815, the linking code is received at the RNS from the first user device. An RNS may include a user interface for a user of the first user device to input the linking code to the RNS.

At step 820, the second user device is associated (i.e., using the linking code) with a user/provider ID that is associated at the RNS with the first user device. In one example, a second device ID is assigned to the second user device and the second device ID is correlated with the user/provider ID (e.g., using information stored in a memory of the RNS). The correlation between the second user device and the user/provider ID can be utilized to provide a notification from a 3PSP associated with the user/provider ID to the second user device and/or the first user device. One or more of the steps of method 800 may be repeated to associate the second user device with additional user/provider ID's for additional 3PSP's that are associated with the first user device.

Referring back to FIG. 6, one example implementation of method 800 includes first user device 615 being associated with a first user/provider ID with first 3PSP 605. In this example, a user of second user device 617 accesses a user interface of RNS 610 (i.e., requests at step 805) to receive from RNS 610 a linking code that associates second user device 617 to RNS 610 (step 810). The user then accesses RNS 610 using first user device 615 and provides the linking code to the RNS 610, for example via an user input interface of RNS 610 (step 815). The RNS associates second user device 617 with the first user/provider ID using the linking code.

The following aspects and features may be combined with any one or more of the implementations discussed above with respect to FIGS. 1 to 8.

Providing of a notification to a user device is a feature of many of the implementations and embodiments discussed above. A notification can be provided to a user device in a variety of ways. In one example, a notification is provided to a user device in a message cue or other user interface. A user interface may provide a user with an indication of how many notifications are available (e.g., how many notifications are available from each 3PSP associated with the RNS). A user of the user device may select a notification from the message cue for display on the user device. Notifications may be organized by 3PSP of origin. Example ways of organizing include, but are not limited to, providing a separate listing of notifications for each 3PSP, indicating for each notification an actual identifier of the 3PSP, indicating for each notification a non-identifying indication for a 3PSP of origin (e.g., using an indicator of “3PSP #1” instead of an explicit identifier such as “Facebook”), indicating for a listing of notifications an actual identifier of the 3PSP, indicating for a listing of notifications a non-identifying indication for a 3PSP of origin, and any combinations thereof. In one example, notifications are only displayed to the user device and not stored on the user device (e.g., using a user interface of the RNS via a web application and/or a client application on the user device). A user device may send a confirmation to an RNS that a notification has been received. In one such example, the RNS permanently deletes the notification from the RNS upon receipt of the confirmation.

A user may be presented with an option via a user interface with the RNS to view a next notification in a cue. A user may be presented with an option via a user interface with the RNS to close the current notification. Other user interfaces with an RNS and/or a 3PSP may be provided to allow a user device to interact with a notification and/or to provide information (e.g., a service ID) or request information (e.g., a service ID, a user/provider ID).

Additional reduction of traceability of a notification can be achieved at a user device in a variety of ways. Example ways to further reduce traceability of a notification include, but are not limited to, preventing copy, cut, and/or paste functionality of a notification; preventing screen capture of a notification; preventing of and deletion of cookies related to a notification; preventing saving a notification (e.g., preventing saving to a memory device associated with a user device); prevention of storage of a notification after a notification is closed from display on a user device; limiting a time a notification is displayed at a user device (e.g., with a predetermined time before automatic deletion), and any combinations thereof.

The following exemplary implementations may be combined with any one or more of the aspects, methodologies, features, and variations of elements described above with respect to the implementations of FIGS. 1 to 8.

In one implementation, a computer implemented method for providing notifications at a user device from an online third-party service provider includes: receiving a first notification from a first third-party service provider at a recordless notification server, the first notification including a first user/provider ID, the first user/provider ID having previously been established via a communication between the recordless notification server and the third-party service provider, the first notification intended for delivery to a user of the first third-party service provider; associating the first user/provider ID using the recordless notification server with a first user device of the user; removing one or more indications of identity of the first third-party service provider from the first notification; and providing the first notification to the first user device without the one or more indications of identity of the first third-party service provider. In one example, the method further includes: receiving a first request from the first user device at the recordless notification server to use the recordless notification server; assigning a device ID to the first user device, the device ID identifying the first user device to the recordless notification server; associating a first service ID with the device ID using the recordless notification server; receiving a communication at the recordless notification server from the first third-party service provider, the communication including the first service ID; and providing the first third-party service provider with the first user/provider ID using the recordless notification server. The providing the user of the first user device with the first service ID may be done such that the user can provide it to the first third-party service provider prior to said receiving a communication from the first third-party service provider. The method may also include receiving a communication at the recordless notification server from a second third-party service provider, the communication including a second service ID; and providing the second third-party service provider with a second user/provider ID using the recordless notification server, the second user/provider ID associating the first user device with the second third-party service provider. In one such example, the first service ID and the second service ID are the same service ID. In another such example, the method includes receiving a second request from the first user device at the recordless notification server to use the recordless notification server; and providing the user of the first user device with the second service ID such that the user can provide it to the second third-party service provider prior to said receiving a communication from the second third-party service provider. In yet another such example, the method includes receiving a second notification from the second third-party service provider at the recordless notification server, the second notification including the second user/provider ID, the second notification intended for delivery to the user of the second third-party service provider; associating the second user/provider ID using the recordless notification server with the first user device; removing one or more indications of identity of the second third-party service provider from the second notification; and providing the second notification to the second user device without the one or more indications of identity of the second third-party service provider.

In another implementation, computerized method of receiving a notification from a third-party service provider includes using a first user device to make a request of a recordless notification server to use the recordless notification server with one or more third-party service providers; receiving from the recordless notification server a service ID; providing the service ID to a first third-party service provider, the service ID configured to allow the recordless notification server to provide a user/provider ID to the first third-party service provider, the user/provider ID configured to allow the recordless notification server to correlate a notification sent from the first third-party service provider to the recordless notification server with the first user device; and receiving the notification at the first user device from the recordless notification server, the notification not having an indication of the identity of the third-party service provider.

In yet another implementation, a computerized method of providing notifications to a user of a third-party service provider includes providing a user of an online third-party service provider with an interface for entering a service ID, the service ID having been provided to the user by a recordless notification server; receiving at the online third-party service provider via the interface the service ID; providing the service ID from the third-party service provider to the recordless notification server; receiving from the recordless notification server a user/provider ID, the user/provider ID configured to allow the recordless notification server to associate the third-party service provider with the user; and providing a notification from the third-party service provider to the recordless notification server, the notification intended for delivery to the user and including the user/provider ID.

In still another implementation, a computer implemented method for receiving notifications at a user device from an online third-party service provider includes receiving a first notification from a first third-party service provider at a recordless notification server, the first notification including a first user/provider ID, the first user/provider ID having previously been established via a communication between the recordless notification server and the third-party service provider, the first notification intended for delivery to a user of the first third-party service provider; associating the first user/provider ID using the recordless notification server with a first user device of the user; checking for one or more indications of identity of the first third-party service provider included with the first notification; removing any one or more indications of identity of the first third-party service provider found in said checking step; and providing the first notification to the first user device without the one or more indications of identity of the first third-party service provider.

It is to be noted that any one or more of the aspects and embodiments described herein may be conveniently implemented using one or more machines (e.g., one or more computing devices that are utilized as a user computing device, one or more computing devices used as a notification server, one or more computing devices used as a part of a 3PSP) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable hardware storage medium. A computer-readable hardware storage medium may be any medium that is capable of storing and/or encoding a sequence of instructions for execution by a machine (e.g., a computing device) and that causes the machine to perform any one of the methodologies and/or embodiments described herein. A computer-readable hardware storage medium includes a physical storage medium. A signal is not a computer-readable hardware storage medium. Examples of a computer-readable hardware storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A computer-readable hardware storage medium, as used herein, is intended to include a single medium as well as a collection of physically separate media, such as, for example, a collection of compact disks or one or more hard disk drives in combination with a computer memory. As used herein, a computer-readable hardware storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

FIG. 9 shows a diagrammatic representation of one embodiment of a computing device in the exemplary form of a computer system 900 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Any one or more aspects and/or methodologies of a component of the present disclosure may be distributed across one or more computing devices. A computing device that is specially programmed to perform one or more aspects and/or methodologies of a component of the present disclosure and includes associated hardware to perform those aspects and/or methodologies is a specialized device for the corresponding functions. For example, an RNS is a specialized device that may include one or more computing devices that are specially programmed and configured to perform one or more of the functions of an RNS as disclosed herein (e.g., generate and manage a user/provider ID and/or remove identifying information of a 3PSP from a notification, etc.).

Computing device 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Memory 910 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 920 (BIOS), including basic routines that help to transfer information between elements within computing device 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof.

Computing device 900 may also include a storage device 930. Examples of a storage device (e.g., storage device 930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 (or one or more components thereof) may be remotely interfaced with computing device 900 (e.g., via an external port connector (not shown)). Particularly, storage device 930 and an associated machine-readable medium 935 may provide nonvolatile and/or volatile storage of machine-readable instructions, data structures, program modules, and/or other data for computer system 900. In one example, software 925 may reside, completely or partially, within machine-readable medium 935. In another example, software 925 may reside, completely or partially, within processor 905.

Computing device 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof. Input device may include a touch screen interface that may be a part of or separate from display 965, discussed further below.

A user may also input commands and/or other information to computing device 900 via storage device 930 (e.g., a removable disk drive, a flash drive, etc.) and/or a network interface device 945. A network interface device, such as network interface device 945 may be utilized for connecting computing device 900 to one or more of a variety of networks, such as network 950, and one or more remote devices 955 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 950, may employ a wired and/or a wireless mode of communication. In general, any network topology may be used. Information (e.g., data, software 925, etc.) may be communicated to and/or from computer system 900 via network interface device 945.

Computing device 900 may further include a video display adapter 960 for communicating a displayable image to a display device, such as display device 965 (e.g., for providing user access to one or more user interfaces. Examples of a display device include, but are not limited to, a liquid crystal display (LCD), a cathode ray tube (CRT), a plasma display, a light emitting diode (LED) display, and any combinations thereof. In addition to a display device, a computing device 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer implemented method for providing notifications at a user device from an online third-party service provider, the method comprising:
receiving a first request from the first user device at the recordless notification server to use the recordless notification server;
assigning a device ID to the first user device, the device ID identifying the first user device to the recordless notification server;
associating a first service ID with the device ID using the recordless notification server;
receiving a first notification from a first third-party service provider at a recordless notification server, the first notification including a first user/provider ID that is based on the first service ID, the first notification intended for delivery to a user of the first third-party service provider; and
providing the first notification to the first user device with the recordless notification server using the first user/provider ID to correlate to the first user device of the user.

2. A method according to claim 1, wherein the first user/provider ID is based on the first service ID by the first user/provider ID having the same value as the first service ID.

3. A method according to claim 1, wherein the first user/provider ID being based on the first service ID includes:
receiving a communication from the first third-party service provider at the recordless notification server, the communication including the first service ID; and
providing the first third-party service provider with the first user/provider ID using the recordless notification server, the first user/provider ID being configured to allow the recordless notification server to correlate the first user/provider ID with the device ID.

4. A method according to claim 3, further comprising:
providing the user of the first user device with the first service ID such that the user can provide it to the first third-party service provider prior to said receiving a communication from the first third-party service provider.

5. A method according to claim 1, further comprising removing one or more indications of identity of the first third-party service provider from a network information layer of the first notification prior to said providing the first notification to the first user device.

6. A method according to claim 5, further comprising removing one or more indications of identity of the first third-party service provider from a payload information layer of the first notification prior to said providing the first notification to the first user device.

7. A method according to claim 1, further comprising:
associating a second service ID with the device ID using the recordless notification server;
receiving a second notification from a second third-party service provider at the recordless notification server, the second notification including a second user/provider ID that is based on the second service ID, the second notification intended for delivery to the user of the second third-party service provider;
providing the second notification to the first user device with the recordless notification server using the second user/provider ID to correlate to the first user device of the user.

8. A method according to claim 7, further comprising removing one or more indications of identity of the first third-party service provider from a network information layer of the first notification prior to said providing the first notification to the first user device.

9. A method according to claim 8, further comprising removing one or more indications of identity of the first third-party service provider from a payload information layer of the first notification prior to said providing the first notification to the first user device.

10. A method according to claim 7, wherein the second user/provider ID is based on the second service ID by the second user/provider ID having the same value as the second service ID.

11. A method according to claim 7, wherein the second user/provider ID being based on the second service ID includes:
receiving a communication from the second third-party service provider at the recordless notification server, the communication including the second service ID; and
providing the second third-party service provider with the second user/provider ID using the recordless notification server, the second user/provider ID being configured to allow the recordless notification server to correlate the second user/provider ID with the device ID.

12. A method according to claim 11, further comprising:
receiving a second request from the first user device at the recordless notification server to use the recordless notification server; and
providing the user of the first user device with the second service ID such that the user can provide it to the second third-party service provider prior to said receiving a communication from the second third-party service provider.

13. A method according to claim 7, wherein the first service ID and the second service ID are the same service ID.

14. A method according to claim 1, further comprising:
receiving from the first user device at the recordless notification server a request to link a second user device of the user to the recordless notification server;
providing the first user device with a linking code from the recordless notification server, the linking code being associated at the recordless notification server with the first user device;
receiving the linking code from the second user device at the recordless notification server; and
associating the second user device with the first user/provider ID.

15. A method according to claim 14, further comprising providing at the second user device an interface to the recordless notification server, the interface configured to allow the user of the second user device to enter the linking code.

16. A method according to claim 14, further comprising providing the first notification to the second user device.

17. A method according to claim 16, wherein said providing the first notification to the second user device include providing the notification without one or more indications of identity of the first third-party service provider in a network information layer of the notification.

18. A method according to claim 1, further comprising:
receiving from a second user device at the recordless notification server a request to link the second user device of the user to the recordless notification server;
providing the second user device with a linking code from the recordless notification server, the linking code being associated at the recordless notification server with the second user device;
receiving the linking code from the first user device at the recordless notification server; and
associating the second user device with the first user/provider ID.

19. A computer readable hardware storage medium containing computer executable instructions implementing a method of providing notifications at a user device from an online third-party service provider, the instructions comprising:
a set of instructions for receiving a first request from the first user device at the recordless notification server to use the recordless notification server;
a set of instructions for assigning a device ID to the first user device, the device ID identifying the first user device to the recordless notification server;
a set of instructions for associating a first service ID with the device ID using the recordless notification server;
a set of instructions for receiving a first notification from a first third-party service provider at a recordless notification server, the first notification including a first user/provider ID that is based on the first service ID, the first notification intended for delivery to a user of the first third-party service provider; and
a set of instructions for providing the first notification to the first user device with the recordless notification server using the first user/provider ID to correlate to the first user device of the user.

20. A system for providing notifications at a user device from an online third-party service provider, the system comprising:
a means for receiving a first request from the first user device at the recordless notification server to use the recordless notification server;
a means for assigning a device ID to the first user device, the device ID identifying the first user device to the recordless notification server;
a means for associating a first service ID with the device ID using the recordless notification server;
a means for receiving a first notification from a first third-party service provider at a recordless notification server, the first notification including a first user/provider ID that is based on the first service ID, the first notification intended for delivery to a user of the first third-party service provider; and
a means for providing the first notification to the first user device with the recordless notification server using the first user/provider ID to correlate to the first user device of the user.
